(19) United States
(12) Patent Application Publication
(10) Pub. No.: US 2013/0133288 A1
(43) Pub. Date: May 30, 2013

(54) ADAPTIVE COVER FOR SEALING MULTIPLE OBJECTS HAVING IRREGULAR SHAPES AND METHOD OF USING AND MANUFACTURING THE SAME

(71) Applicant: Cloud Hidden Design LLC, Gilbert, AZ (US)

(72) Inventor: James Alan Kaslik, Gilbert, AZ (US)

(73) Assignee: CLOUD HIDDEN DESIGN LLC, Gilbert, AZ (US)

(21) Appl. No.: 13/750,132

(22) Filed: Jan. 25, 2013

Related U.S. Application Data
(63) Continuation of application No. PCT/US2011/045202, filed on Jul. 25, 2011.
(60) Provisional application No. 61/367,586, filed on Jul. 26, 2010.

(51) Int. Cl. B65D 65/04; B29C 69/00; B65B 17/00; B65D 51/24; B65D 43/02

(52) U.S. Cl. CPC B65D 65/04; B65D 51/24; B65D 43/0222; B65B 17/00; B29C 69/00
USPC 53/396; 220/212; 220/305; 29/428; 428/34.8; 428/36.92; 428/36.8; 99/484; 99/645; 264/328.1

(57) ABSTRACT

Some embodiments include an adaptive cover for sealing multiple objects having irregular shapes. Other embodiments of related systems and methods are also disclosed.

### CROSS-REFERENCE TO RELATED APPLICATIONS

This application is a continuation of International Patent Application Serial No. PCT/US2011/045202, filed Jul. 25, 2011. International Patent Application Serial No. PCT/US2011/045202 claims the benefit of U.S. Provisional Patent Application No. 61/367,586, filed Jul. 26, 2010. International Patent Application Serial No. PCT/US2011/045202 and U.S. Provisional Patent Application No. 61/367,586 are incorporated herein by reference in their entirety.

### FIELD OF THE INVENTION

This invention relates generally to adaptive covers, and relates more particularly to covers that seal multiple objects having irregular shapes and methods of using and manufacturing the same.

### DESCRIPTION OF THE BACKGROUND

Covering systems exist for a wide variety of objects and containers, but existing covers have various problems or limitations. For example, fitted lids, such as Glad®, Tupperware®, or Rubbermaid® lids have fixed forms and therefore cannot cover multiple containers. Furthermore, fitted lids cannot cover over-filled containers or objects that do not fit in the container for which the fitted lids are designed. Meanwhile, laminar covers, such as aluminum foil, wax paper, or plastic film provide an incomplete seal and are prone to coming loose, leaking, and tearing. Furthermore, most laminar covers offer single or few uses. Likewise, covering systems that include peripheral strips of elastic have gathers that limit their ability to seal against leakage or air infiltration. Furthermore, covering systems that include an adhesive strip are generally limited to use with certain materials and to certain conditions. For example, condensation can reduce adhesion and make such covers ineffective.

Accordingly, a need or potential for benefit exists for an apparatus or system that can seal multiple objects having irregular shapes.

### BRIEF DESCRIPTION OF THE DRAWINGS

To facilitate further description of the embodiments, the following drawings are provided in which:

FIG. 1 illustrates a top, side isometric view of a cover configured to be detachably secured to multiple objects having irregular shapes, according to a first embodiment;

FIG. 2 illustrates the cover of FIG. 1 in a bottom orthogonal view, according to the first embodiment;

FIG. 3 illustrates the cover of FIG. 1 in a first side orthogonal view, according to the first embodiment;

FIG. 4 illustrates the cover of FIG. 1 in a second side orthogonal view, according to the first embodiment;

FIG. 5 illustrates the cover of FIG. 1 in a top, side isometric view, according to the first embodiment;

FIG. 6 illustrates a cover similar to the cover of FIG. 1, but having at least one overmolded panel coupled to the cover wall, according to a second embodiment;

FIG. 7 is a flow chart illustrating an embodiment of a method of manufacturing a cover configured to be detachably secured to multiple objects having irregular shapes.

FIG. 8 illustrates gripping forces provided by the cover of FIG. 1 compared to the prior art, according to the first and second embodiments;

FIG. 9 illustrates the cover of FIG. 1 covering a bowl of pancake batter with handles and pouring spouts integral with the rim, according to the first embodiment;

FIG. 10 illustrates the cover of FIG. 1 covering a melon with a quarter section removed, according to the first embodiment;

FIG. 11 illustrates the cover of FIG. 1 covering a plate of cookies, according to the first embodiment;

FIG. 12 illustrates the cover of FIG. 1 covering an avocado with a pit, according to the first embodiment;

FIG. 13 illustrates the cover of FIG. 1 covering a bowl of blueberries with an uneven surface, according to the first embodiment;

FIG. 14 illustrates a cover similar to the cover of FIG. 1, but having at least one passage for a straw, according to a third embodiment:

FIG. 15 illustrates a pair of overmolded panels that can be molded to the cover of FIG. 6, according to the second embodiment:

FIG. 16 illustrates the cover of FIG. 6 prior to having at least one overmolded panel coupled to the wall, according to the second embodiment; and

FIG. 17 illustrates a cover similar to the cover of FIG. 1, but having at least one passage for straining liquid from the object of the multiple objects, according to a fourth embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant. “Mechanical coupling” and the like should be broadly understood and include mechanical coupling of all types.

The absence of the word “removably,” “removable,” and the like near the word “coupled,” and the like does not mean that the coupling, etc. in question is or is not removable. For example, the recitation of an overmolded panel being coupled to a spheroid does not mean that the overmolded panel cannot be removed (readily or otherwise) from, or that it is permanently connected to, the spheroid.

### DETAILED DESCRIPTION OF EXAMPLES OF EMBODIMENTS

Some embodiments include a cover configured to be detachably secured to multiple objects having irregular shapes. The cover comprises a spheroid comprising a hollow interior and a wall. The wall can comprise a material, an outer surface, an inner surface, and an aperture providing an opening through the wall into the hollow interior. The spheroid can be configured to be altered from a relaxed state to a deformed state without permanently deforming the spheroid. When the spheroid is in the relaxed state, the hollow interior can have a first greatest dimension and the aperture can have a second greatest dimension smaller than the first greatest dimension. When the spheroid is in the deformed state, the spheroid can be configured to conform to any object of the multiple objects and to provide a seal for the object of the multiple objects. When the spheroid is in the deformed state, the spheroid can be capable of providing forces in three dimensions such that the spheroid is capable of gripping the object in the three dimensions.

Other embodiments include a method of covering multiple objects having irregular shapes. The method can comprise sealing an inner surface of a spheroid to any object of the multiple objects. The wall can comprise an outer surface, an inner surface, and an aperture providing an opening through the wall into the hollow interior. The spheroid can be configured to be altered from a relaxed state to a deformed state without permanently deforming the spheroid. When the spheroid is in the relaxed state, the hollow interior can have a first greatest dimension and the aperture can have a second greatest dimension smaller than the first greatest dimension. When the spheroid is in the deformed state, the spheroid can be configured to conform to any object of the multiple objects and to provide a seal for the object of the multiple objects. When the spheroid is in the deformed state, the spheroid can be capable of providing forces in three dimensions such that the spheroid is capable of gripping the object in the three dimensions.

Further embodiments include a method of manufacturing a cover configured to be detachably secured to multiple objects having irregular shapes. The method can include molding a spheroid having a hollow interior and a wall. In some embodiments, the spheroid can comprise an outer surface, an inner surface, and an aperture providing an opening through the wall into the hollow interior. In various embodiments, the spheroid can be configured to be altered from a relaxed state to a deformed state without permanently deforming the spheroid. In further embodiments, when the spheroid is in the relaxed state, the hollow interior can have a first greatest dimension and the aperture can have a second greatest dimension smaller than the first greatest dimension. In other embodiments, when the spheroid is in the deformed state, the spheroid can be capable of providing forces in three dimensions such that the spheroid is capable of gripping the object in the three dimensions.

Further embodiments include a method of manufacturing a cover configured to be detachably secured to multiple objects having irregular shapes. The method can comprise molding a spheroid having a hollow interior and a wall. The wall can comprise an outer surface, an inner surface, and an aperture providing an opening through the wall into the hollow interior. The spheroid can be configured to be altered from a relaxed state to a deformed state without permanently deforming the spheroid. When the spheroid is in the relaxed state, the hollow interior can have a first greatest dimension and the aperture can have a second greatest dimension smaller than the first greatest dimension. When the spheroid is in the deformed state, the spheroid can be configured to conform to any object of the multiple objects and to provide a seal for the object of the multiple objects. When the spheroid is in the deformed state, the spheroid can be capable of providing forces in three dimensions such that the spheroid is capable of gripping the object in the three dimensions.

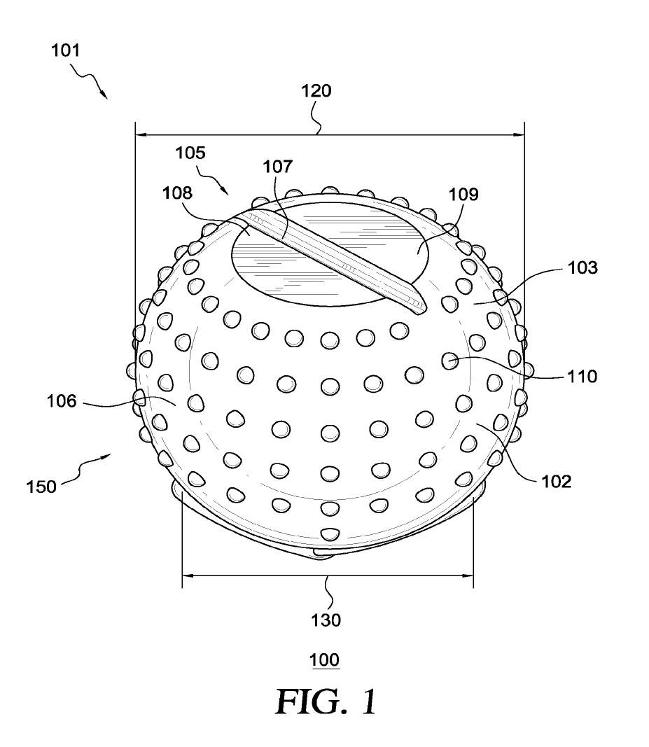

Turning to the drawings, FIG. 1 illustrates a top, side isometric view of a cover 100 configured to be detachably secured to multiple objects having irregular shapes, according to a first embodiment of cover 100. Cover 100 is merely exemplary and is not limited to the embodiments presented herein. Cover 100 can be employed in many different embodiments or examples not specifically depicted or described herein.

In many embodiments, the multiple objects having irregular shapes can comprise at least two of: an exposed portion of at least half or less than half of a melon; a container having an opening and an exterior surface adjacent to the opening, where at least one of the opening or the exterior surface adjacent to the opening is uneven; an exposed internal section of a piece of produce; a receptacle having a height above which are perishable goods; or a pitcher having at least one spout. In some embodiments, a melon can comprise at least one fruit or vegetable of any member of the cucurbitaceae plant family. In some embodiments, a container can comprise at least one of a beaker, a bin, a bottle, a bowl, a box, a bucket, a can, a canister, a cannikin, a canteen, a carafe, a carton, a cask, a casserole, a chalice, a crate, a crock, a cup, a demitasse, a dish, an ewer, a firkin, a flask, a glass, a goblet, a grail, a jar, a jeroboam, a jug, a kettle, a magnum, a measuring cup, a mug, a pail, a pot, a stein, a taster, a teacup, a tub, a tumbler, a vase, a vat, a vessel, or a vial. In some embodiments, a receptacle can comprise at least one of a container, a plate, a platter, a porringer, a salver, a saucer, or a tray. In some embodiments, a pitcher can comprise at least one device for pouring liquids. In some embodiments, the container, receptacle, or pitcher can have handles.

In many embodiments, the multiple objects comprise at least two of: at least half or less than half of a melon; at least half or less than half of an avocado having a pit of the avocado still remaining; at least half or less than half of a mango having a pit of the mango still remaining; at least half or less than half of a pineapple; at least half or less than half of a piece of citrus fruit (e.g., an orange, a grapefruit, a lime, a lemon, etc.); a cucumber having an exposed surface of the cucumber, where the exposed surface of the cucumber is uneven; at least half or less than half of a pear; at least half or less than half of a coconut; at least half or less than half of a pepper; at least half or less than half of an onion; at least half or less than half of an apple; at least half or less than half of a tomato; at least half or less than half of any other suitable produce (e.g., an exposed portion of the produce); a measuring cup having at least one spout; a gravy boat having at least one spout; a cut block of cheese; an open container of paint; an open can of soup; a juice glass; a wine glass; a champagne flute; a can of tuna fish; a dish having a first opening and a first exterior surface adjacent to the opening, where at least one of the first opening or the first exterior surface adjacent to the opening is uneven; a bowl having a second opening and a second exterior surface adjacent to the opening, where at least one of the second opening or the second exterior surface adjacent to the opening is uneven; a vessel for fluids having a third opening and a third exterior surface adjacent to the opening, where at least one of the third opening or the third exterior surface adjacent to the opening is uneven; a first receptacle, where the first receptacle has a first height above which are first perishable goods comprising at least one hamburger; a second receptacle, where the second receptacle has a second height above which are second perishable goods comprising at least one sandwich; and a third receptacle, where the third receptacle has a third height above which are third perishable goods comprising at least one piece of produce. In some embodiments, the vessel for fluids comprises at least one of a cup, mug, or glass.

In many embodiments, cover 100 also can be detachably secured to multiple objects having regular shapes.

Cover 100 can be cleanable, reusable, and/or recyclable. In other embodiments, cover 100 can be none of cleanable, reusable, or recyclable. In some embodiments, cover 100 can be one continuous piece of material to provide for ease of use, maintenance, and manufacture.

Cover 100 can comprise a spheroid 101. The term “spheroid” as used herein can mean a solid geometrical figure having vertical cross sections in the x-z and y-z planes that are substantially round, circular, elliptical, or polygonal with sharp or round corners and having a horizontal cross section in the x-y plane that is substantially round, circular, elliptical, or polygonal with sharp or rounded corners. The term “x-y plane” as used herein can mean a plane formed by all the points being equidistant from the two poles or foci of either the x-z or y-z vertical cross sections. For those embodiments where the poles or foci are not clearly defined by the vertical cross sections, the poles can be the pair of points on the vertical cross sections forming a line about which the particular vertical cross section is symmetrical. The term “x-z plane” as used herein means a plane that is perpendicular to the x-y plane. The term “y-z plane” is a plane that is perpendicular to both the x-y plane and the x-z plane so that the x-y, x-z, and y-z planes combine to create a three-dimensional Cartesian coordinate system comprised of x-, y-, and z-axes. Spheroid 101 can comprise a shape of at least one of a sphere, an ellipsoid, a spherical cap, a spherical frustum, or any three dimensional polygon having a substantially spherical shape. The term “spherical cap” as used herein can mean a solid geometrical figure defined by the region of a sphere that is above or below a first geometric plane intersecting the sphere. The term “spherical frustum” as used herein can mean a solid geometrical figure defined by a portion of a sphere that is between a first geometric plane intersecting the sphere and a second geometric plane intersecting the sphere but not intersecting the first geometric plane at any point within the volume of the sphere. In some embodiments, spheroid 101 can be conical or prismatic in shape. In various embodiments, the horizontal cross section of spheroid 101 can comprise a circle, an ellipse, a rectangle, a triangle, a different polygon, or an arbitrary shape such as a star.

Spheroid 101 and/or wall 102 can comprise and/or can be composed of a material that can repeatedly stretch to greater than or equal to 1000% its relaxed size, or at least greater than or equal to 500%, and return to its relaxed size without distortion. Meanwhile, spheroid 101 and/or wall 102 can comprise and/or can be composed of a material having an elongation at break greater than or equal to 1000%. The term “elongation at break” as used herein can mean a percentage of tensile elongation a material can undergo at which the material will rupture. Likewise, spheroid 101 and/or wall 102 can comprise and/or can be composed of a material having a tensile modulus at 100% of less than approximately 138 kilopascals (kPa). The term “tensile modulus at 100%” as used herein can mean the tensile stress of a material when the material has been elongated by 100%. Additionally, spheroid 101 and/or wall 102 can comprise and/or can be composed of a material having a hardness of less than or equal to 8±3 Shore A or at least less than or equal to 10 Shore A. Furthermore, spheroid 101 and/or wall 102 can comprise and/or can be composed of a material meeting the United States Food and Drug Administration's requirements for repeated contact with food.

For example, spheroid 101 and/or wall 102 can comprise and/or can be composed of a material having an elongation at break greater than or equal to 1134%. Meanwhile, spheroid 101 and/or wall 102 can comprise and/or can be composed of a material having a tensile modulus at 100% of less than approximately 28.5 kilopascals (kPa). Likewise, spheroid 101 and/or wall 102 can comprise and/or can be composed of a material having a hardness of less than or equal to 15±3 Shore 00.

Meanwhile, spheroid 101 and/or wall 102 can comprise and/or can be composed of a material comprising a thermoplastic elastomer and/or a thermoplastic rubber. For example, the material of spheroid 101 can comprise a styrene block copolymer, a hydrogenated isoprene, a silicone polymer and/or a urethane polymer. In some embodiments, spheroid 101 and/or wall 102 can comprise at least one color.

In some embodiments, spheroid 101 and/or wall 102 does not have sharp corners in order to reduce the formation of localized stresses. In the same or different embodiments, spheroid 101 and/or wall 102 does not have at least one of long draws, deep blind pockets, ribs, inconsistent thickness, or sharp changes in thickness to reduce flow problems.

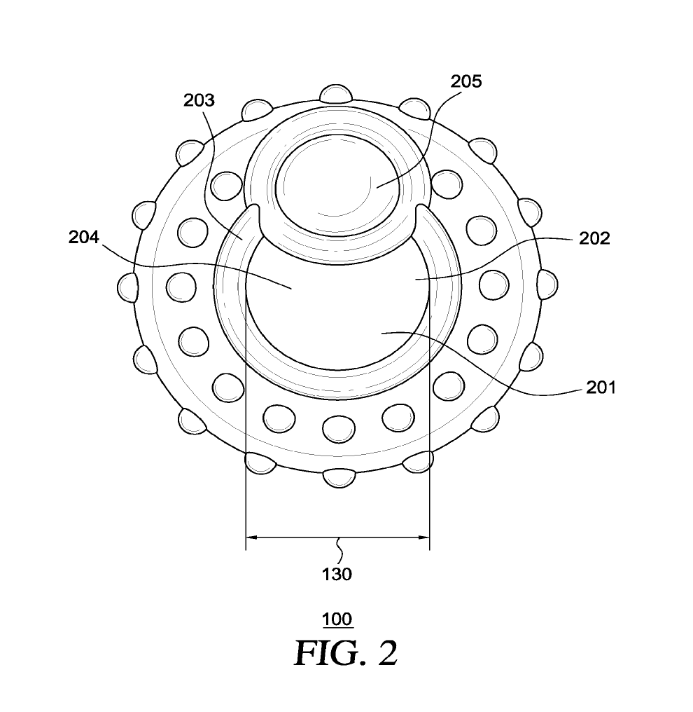

Spheroid 101 comprise hollow interior 201 (FIG. 2) and wall 102. Wall 102 can comprise outer surface 103, inner surface 204 (FIG. 2), and aperture 202 (FIG. 2) providing an opening through wall 102 into hollow interior 201. Wall 102 can have a thickness greater than or equal to approximately 0.79 millimeters (mm) and less than or equal to approximately 3.18 mm. For example, wall 102 can be approximately 1.59 mm thick.

In some embodiments, outer surface 103 can be textured and/or inner surface 204 can be smooth. The textured surface of outer surface 103 can decrease the appearance of finger prints or other dirt on outer surface 103. Meanwhile, the textured surface of outer surface 103 can decrease the ability of outer surface 103 to be self-adhering. In some embodiments, outer surface 103 can look similar to frosted glass.

In some embodiments, aperture 202 can be circular or elliptical. Likewise, aperture 202 can be planar. In other embodiments, aperture 202 can be non-planar. In some embodiments, aperture 202 can be a linear, wedged, or curved shape when viewed in profile. In various embodiments, where aperture 202 has a linear shape, aperture 202 can provide an opening fitting a great number and variety of objects. In other embodiments, where aperture 202 has a wedged or curved shape, aperture 202 can provide a deeper portion of cover 100 to grip the object and a shallower portion of cover 100 that can flex and fold to accommodate angled or irregular shaped objects without excessive stretching or gaping.

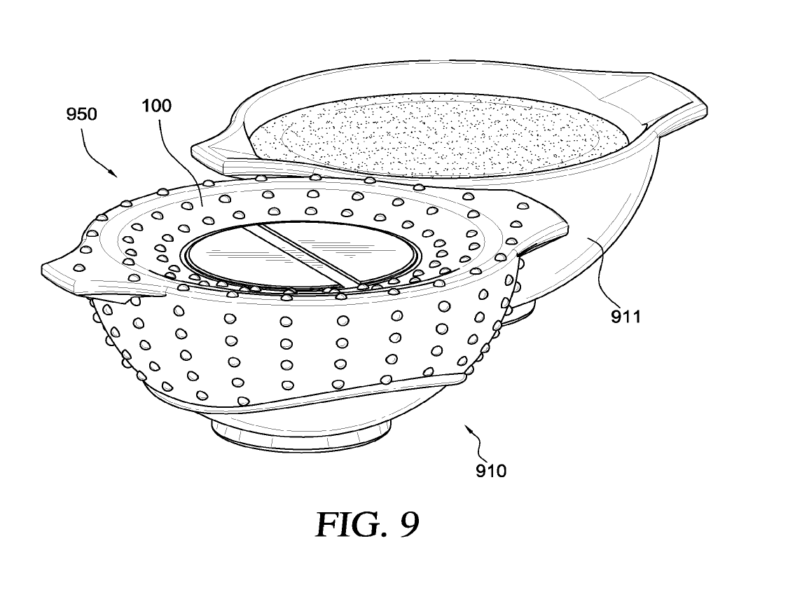

Spheroid 101 can be configured to be altered from relaxed state 150, one embodiment of which is illustrated in FIG. 1, to deformed state 950, one embodiment of which is illustrated in FIG. 9, without permanently deforming spheroid 101. In many embodiments, spheroid 101 can be configured to be flexed, stretched, twisted, and/or hinged.

In various embodiments, when spheroid 101 is in deformed state 950, spheroid 101 and/or wall 102 can be configured to conform to any object of the multiple objects and to provide a seal for the object of the multiple objects. Likewise, spheroid 101 and/or wall 102 can be configured to prevent the leaking or spilling of fluids from the object of the multiple objects. In the same or different embodiments, where the object of the multiple objects has a natural skin or rind, spheroid 101 and/or wall 102 can be configured to provide a seal against the natural skin or rind of the object of the multiple objects. The natural skin or rind can have a smooth or uneven surface. Spheroid 101 and/or wall 102 can be configured to provide a complete seal without use of adhesives, undercuts, grooves, flanges, or other contrivances to effect the seal. In some embodiments, spheroid 101 and/or wall 102 can be configured to be stretched and/or pressed along outer surface 103 to expel air within cover 100 and to create a partial vacuum to help preserve the freshness of the object of the multiple objects.

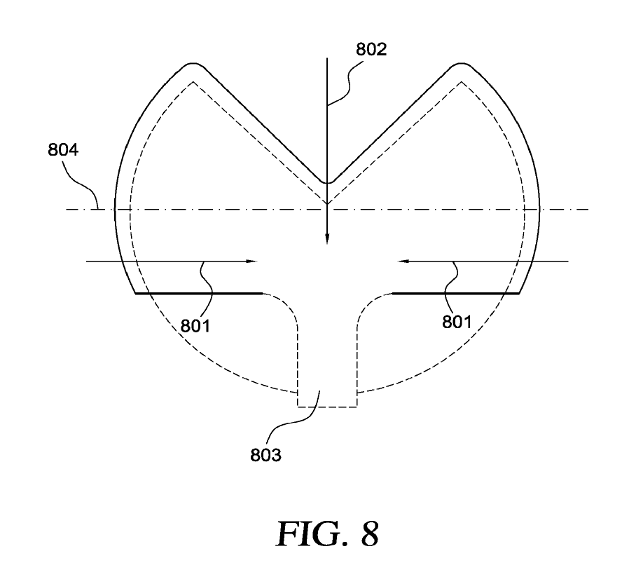

In still other embodiments, when spheroid 101 is in deformed state 950, spheroid 101 and/or wall 102 can be capable of providing forces in three dimensions such that spheroid 101 and/or wall 102 can be capable of gripping the object in the three dimensions. Accordingly, as shown in FIG. 8, in some embodiments, spheroid 101 can provide both horizontal forces 801, acting in the x-y plane, and vertical forces 802, acting in the x-z plane and y-z planes, on the object. FIG. 8 shows the summed forces provided by the cover in the x-y and y-z planes. The x-z forces would be acting perpendicularly to the surface of FIG. 8. As FIG. 8 further illustrates, in various embodiments, spheroid 101 can generate equivalent vertical forces 802 to what a theoretical elastic band 803 would generate on the object, because spheroid 101 extends below centerline 804 of the object or extends at least below the widest part of the object.

In these or other embodiments, when the spheroid 101 is in relaxed state 150, hollow interior 201 (FIG. 2) can have first greatest dimension 120 (FIG. 1) and aperture 202 (FIG. 2) can have second greatest dimension 130 (FIGS. 1 and 2) smaller than first greatest dimension 120. Further, top region 105 (FIG. 1), as described below, can comprise a third greatest dimension. The third greatest dimension can be smaller than first greatest dimension 120 (FIG. 1). The third greatest dimension can be larger than, smaller than, and/or approximately equal to second greatest dimension 130 (FIGS. 1 and 2). First greatest dimension 120 can be greater than or equal to approximately 1.905 centimeters (cm) and less than or equal to approximately 15.24 cm. In some embodiments, each spheroid in a set of three spheroids can have a different sized first greatest dimension 120 of less than or equal to approximately 3.81 cm, less than or equal to approximately 6.35 cm; and less than or equal to approximately 15.24 cm. In these embodiments, each spheroid in the set of three spheroids can be similar or identical to spheroid 101.

In some embodiments, inner surface 204 (FIG. 2) of wall 102 can be configured to provide a seal at every point of contact inner surface 204 makes with the object of the multiple objects. In some embodiments, inner surface 204 can be configured to form a seal with a dry surface of the object of the multiple objects. In the same or different embodiments, inner surface 204 (FIG. 2) can be configured form a seal with a wet surface of the object of the multiple objects. In some embodiments, inner surface 204 (FIG. 2) can form a seal with a smooth surface of the object of the multiple objects and/or can form a seal with a textured surface of the object of the multiple objects.

As illustrated in FIG. 1, in some embodiments, outer surface 103 of wall 102 can comprise top region 105 opposite aperture 202 (FIG. 2) and at least one other portion 106; however, in other embodiments, outer surface 103 does not include at least one of the top region 105 and/or at least one other portion 106. In various embodiments, top region 105 can be substantially flat. In some embodiments, top region 105 can be filleted around its perimeter. In the same or different embodiments, the radius of curvature for the fillet around the perimeter of top region 105 can be at least three times the thickness of wall 102 to prevent the formation of localized stresses in spheroid 101 during deformation.

In the embodiment of FIG. 1, top region 105 can comprise hinge 107. Hinge 107 can comprise the same thickness as wall 102. In other embodiments, hinge 107 can comprise a thickness greater than the thickness of wall 102. In some embodiments, hinge 107 can comprise a thickness less than the thickness of wall 102. In the same or different embodiments, hinge 107 can have filleted edges with a radius between half the thickness and the full thickness of wall 102 to avoid forming localized stresses from sharp corners.

In various embodiments, hinge 107 divides top region 105 into at least a first panel 108 and a second panel 109. In some embodiments, top region 105 can comprise multiple hinges and three or more panels. In other embodiments, top region 105 has neither hinges nor panels. In many embodiments, first panel 108 and second panel 109 can be substantially equally sized. In various other embodiments, at least one of the panels can be differently sized than at least one of the other panels. In the exemplary embodiment illustrated in FIG. 1, hinge 107 is depressed; however, in other embodiments, at least one of the hinges of top surface 105 can be depressed or protuberant or, in embodiments with multiple hinges, some combination of both. In some embodiments, hinge 107 can comprise a suitable width and can be sufficiently flexible to allow hinge 107 to bend such that the outer surface of panel 108 is flush with the outer surface of panel 109. In the same or different embodiments, hinge 107 can have a width greater than or equal to double the width of at least panel 108 and/or panel 109 to provide sufficient room for the top region 105 to fold onto itself.

In some examples, when spheroid 101 is in relaxed state 150, first panel 108 can be either coplanar or non-coplanar with second panel 109. In other examples, when spheroid 101 is in deformed state 950 (FIG. 9), first panel 108 can be either coplanar or non-coplanar with the second panel 109. In further examples, at least one of the panels of top region 105 can be coplanar or non-coplanar with at least one other panel of top region 105 when spheroid 101 is in relaxed state 150. Meanwhile, in these further examples, at least one of the panels of top region 105 can be coplanar or non-coplanar with at least one other panel of top region 105 when spheroid 101 is in deformed state 950 (FIG. 9).

In other examples, spheroid 101 and/or wall 102 can be thicker at top region 105 and/or at least one panel of top region 105 than at the at least one other portion 106 of outer surface 103. For example, spheroid 101 and/or wall 102 can be approximately twice as thick at top region 105 than at the at least one other portion 106 of outer surface 103. In the same or different examples, the thicker top region 105 or the at least one thickened panel of top region 105 can protect any soft object being covered by cover 100. In many examples, both first panel 108 and second panel 109 can be thicker than at least one other portion 106 of outer surface 103. First panel 108 and second panel 109 can have the same thickness or can have different thicknesses. Still, in further embodiments, at least one of the panels of top region 105 can have the same or different thickness as at least one other panel of top region 105.

As illustrated in FIG. 1, in many embodiments, first panel 108 and/or second panel 109 can be configured to include an identification mark, a logo, and/or a customized label. The identification mark, logo, and/or customizable label can be debossed, embossed, and/or stamped with ink. In other embodiments, when top region 105 does not include first panel 108 and/or second panel 109, top region 105 can be configured to include an identification mark, a logo, and/or a customized label. The identification mark, logo, and/or customizable label can be debossed, embossed, and/or stamped with ink. In still other embodiments, any of the panels of top region 105 can be configured to include an identification mark, a logo, and/or a customized label. The identification mark, logo, and/or customizable label can be debossed, embossed, and/or stamped with ink.

In some embodiments, at least one portion of outer surface 103 can comprise nubs 110. In many embodiments, portion 106 can be the same portion as the at least one portion of outer surface 103. FIG. 1 illustrates at least one such embodiment. In other embodiments, all of outer surface 103 can comprise nubs. In still other embodiments, the portion of outer surface 103 comprising nubs can be a portion less than the entire outer surface 103 or portion 106.

In some embodiments, nubs 110 can be spread evenly across outer surface 103 in any of the above mentioned embodiments. Alternatively, nubs 110 can be spread unevenly and/or in discernable and/or indiscernible patterns across outer surface 103 in any of the above mentioned embodiments. In some embodiments, each of nubs 110 can comprise the shape of a hemisphere, a cone, a pyramid, and/or a prism. In other embodiments, nubs 110 can have other geometrical figures or images, such as an image of a face, animal, fruit, and/or vegetable. Nubs 110 can all be the same figure or image, or can be some combination of different figures or images. In various embodiments, nubs 110 can be convex or protruding. In other embodiments, nubs 110 can be concave or receding. In still further embodiments, nubs 110 can be some combination of convex, protruding, concave, and/or receding. In some embodiments, nubs 110 can be configured to prevent outer surface 103 from self-adhering and/or from adhering to adjacent objects by presenting an uneven surface. In other embodiments, nubs 110 also can be configured to provide a stable base, alone, or, for embodiments having a thickened top region 105, in combination with top region 105, or cover 100. In some embodiments, cover 100 also can serve as a coaster or cozy. For example, where spheroid 101 has an oblate ellipsoidal shape, cover 100 can be applied to cover the object of the multiple objects while the object is being carried across the room, and then removed and applied to the base to serve as a coaster, allowing the object to be safely set anywhere without need for a separate coaster.

Referring back to the figures, FIG. 2 illustrates cover 100 (FIG. 1) in a bottom orthogonal view, according to the first embodiment of cover 100. In many embodiments, outer surface 103 (FIG. 1) can comprise an annular ring 203 around aperture 202. In some embodiments, annular ring 203 can be approximately twice the thickness of wall 102 (FIG. 1). In the same or different embodiments, annular ring 203 can provide a thickened and rounded edge to wall 102 (FIG. 1) to increase the durability of wall 102 near aperture 202, and thereby, to decrease the likelihood of wall 102 tearing near aperture 202. In some embodiments, annular ring 203 can extend only to outer surface 103 (FIG. 1) and not to inner surface 204 where it could create a bump that could reduce the effectiveness of the seal.

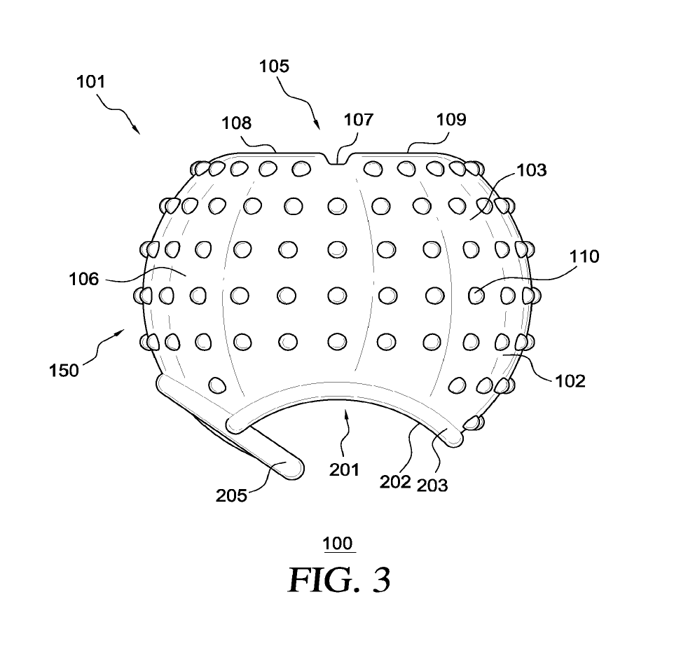

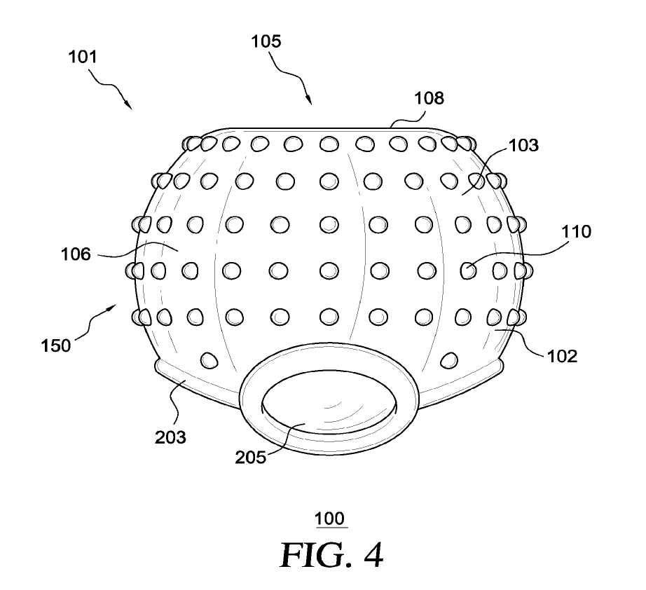

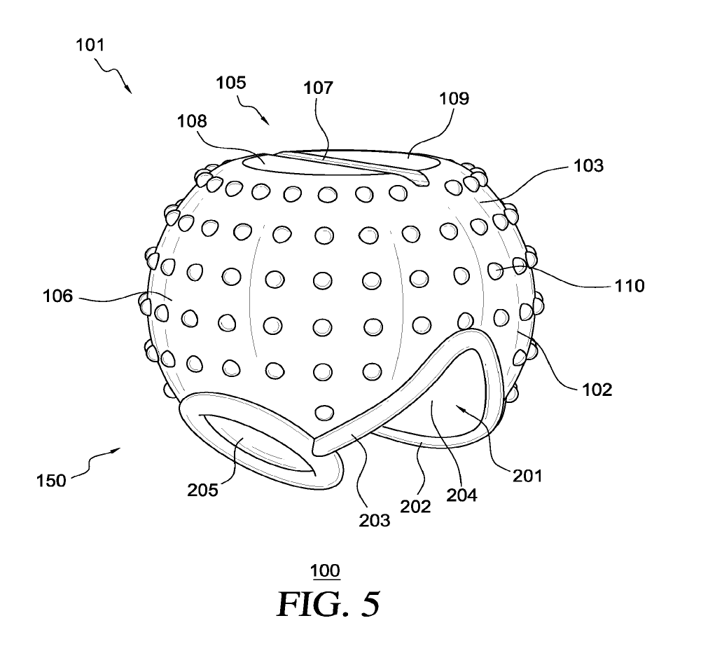

In other embodiments, outer surface 103 (FIG. 1) can comprise at least one tab 205 adjacent to aperture 202. In many embodiments, tab 205 can comprise at least one of a circle or other geometric shape. In various embodiments, tab 205 can be flat or raised. In other embodiments, tab 205 can have a diameter greater than or equal to approximately 1.27 cm and less than or equal to 3.18 cm. For example, tab 205 can have a diameter of 1.91 cm. In some embodiments, outer surface 103 (FIG. 1) can comprise multiple tabs where each of the tabs comprise the same shape or each of the tabs comprise some combination of different shapes. In various embodiments, tab 205 can be configured to serve as a handle to provide a non-tensioned section of material to help remove cover 100 (FIG. 1) from an object to which cover 100 is sealed. In the same or different embodiments, tab 205 can be configured to be grasped between a thumb and a forefinger for easy removal of cover 100 (FIG. 1). FIG. 3 and FIG. 4 illustrate cover 100 of FIG. 1 and FIG. 2 in side orthogonal views, according to the first embodiment of cover 100. FIG. 5 illustrates cover 100 of FIG. 1-FIG. 4 in a top, side isometric view.

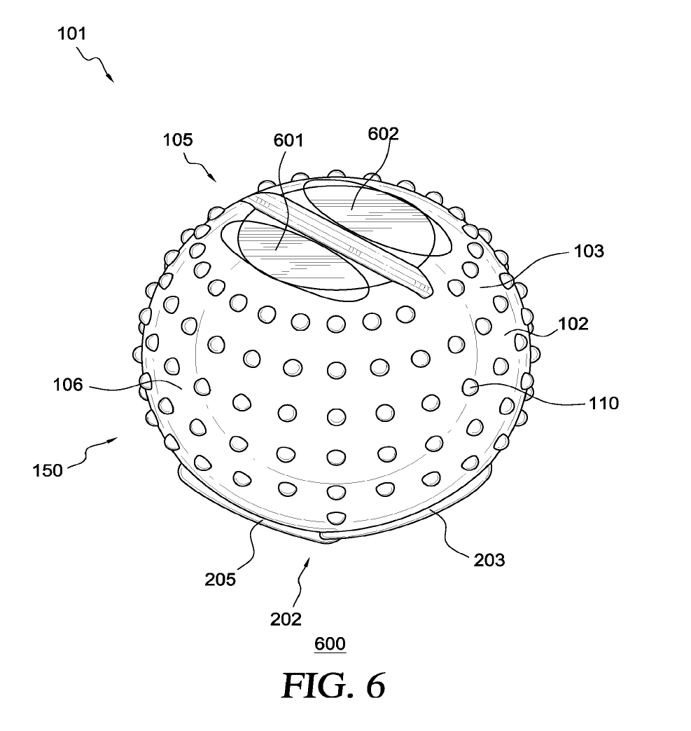

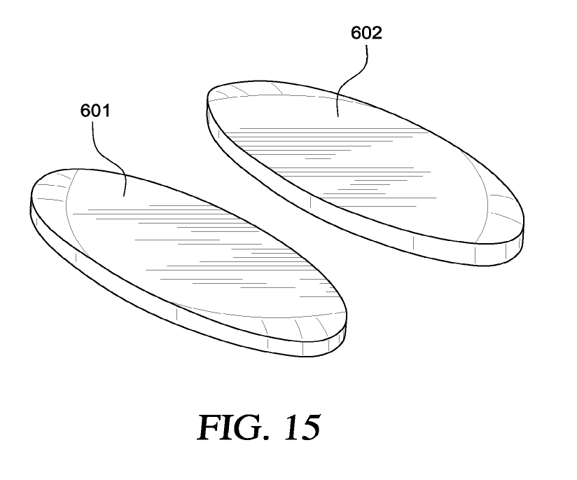

As illustrated in FIG. 6, in some embodiments, a cover 600 can be similar to cover 100. In many embodiments, cover 600 can comprise a first overmolded panel 601 (FIG. 15) coupled to wall 102 (FIG. 1). In the same or different embodiments, cover 600 can comprise a second overmolded panel 602 (FIG. 15). In other embodiments, cover 600 does not include a second overmolded panel 602. In some embodiments, overmolded panel 601 and overmolded panel 602 can be molded to wall 102 (FIG. 1).

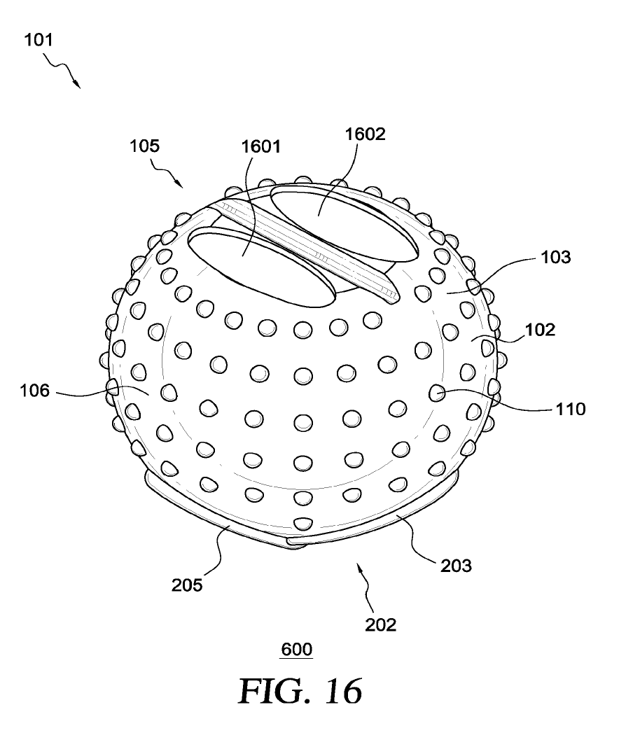

As illustrated in FIG. 16, in the same or different embodiments, overmolded panel 601 and overmolded panel 602 (FIG. 15) can be separate from cover 600 prior to being molded to wall 102. In many embodiments, cover 600 can comprise a first recess 1601 configured to receive overmolded panel 601 and a second recess 1602 configured to receive overmolded panel 602. In many other embodiments, overmolded panel 601 and overmolded panel 602 (FIG. 15) can be configured to receive cover 600, thereby forming first recess 1601 and second recess 1602.

Returning to FIG. 6, in some embodiments, overmolded panel 601 and overmolded panel 602 can be a shape comprising at least a circle, oval, or polygon. In some embodiments, overmolded panel 601 and overmolded panel 602 can comprise the same shape. In other embodiments, overmolded panel 601 and overmolded panel 602 can comprise different shapes. In some embodiments, overmolded panel 601 and overmolded panel 602 can be coupled to wall 102 opposite the location of aperture 202. In some embodiments, overmolded panel 601 and overmolded panel 602 can be substantially flat.

In various embodiments, overmolded panel 601 and overmolded panel 602 can comprise a material different from, but compatible with, the material of spheroid 101. In other embodiments, overmolded panel 601 and overmolded panel 602 can comprise the same material as spheroid 101. In further embodiments, overmolded panel 601 and overmolded panel 602 can comprise at least a thermoplastic polymer or a thermoplastic rubber. In the same or different embodiments, overmolded panel 601 and overmolded panel 602 can comprise a hardness that is harder than the hardness of spheroid 101. In some embodiments, overmolded panel 601 and overmolded panel 602 can comprise a hardness of between 15 and 25 Shore A.

In some embodiments, overmolded panel 601 and overmolded panel 602 can be set into and flush with a thickened top region 105. In some embodiments, overmolded panel 601 and overmolded panel 602 can be the same color as spheroid 101. In other embodiments, overmolded panel 601 and overmolded panel 602 can be a different color than spheroid 101.

In some embodiments, overmolded panel 601 and overmolded panel 602 can be configured to include at least one of an identification mark, a logo, or a customized label. In some embodiments, overmolded panel 601 and overmolded panel 602 can comprise a grade of silicone rubber or other elastomer capable of being laser etched. In some embodiments, overmolded panel 601 and overmolded panel 602 can be customized by individual distributors rather than the manufacturer.

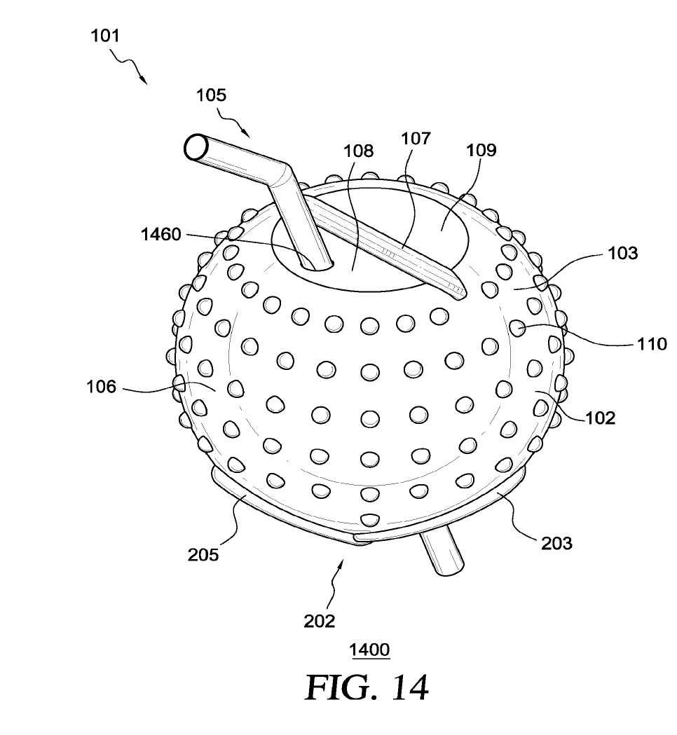

Referring back to the figures, FIG. 14 illustrates a cover 1400 similar to cover 100, according to a third embodiment. In the same or different embodiments, wall 102 of FIG. 14 can further comprise at least one passage 1460 providing an opening through wall 102. In some embodiments, passage 1460 can have a 3.18 mm diameter. In various embodiments, passage 1460 can be used to pass a straw through wall 102 of cover 1400.

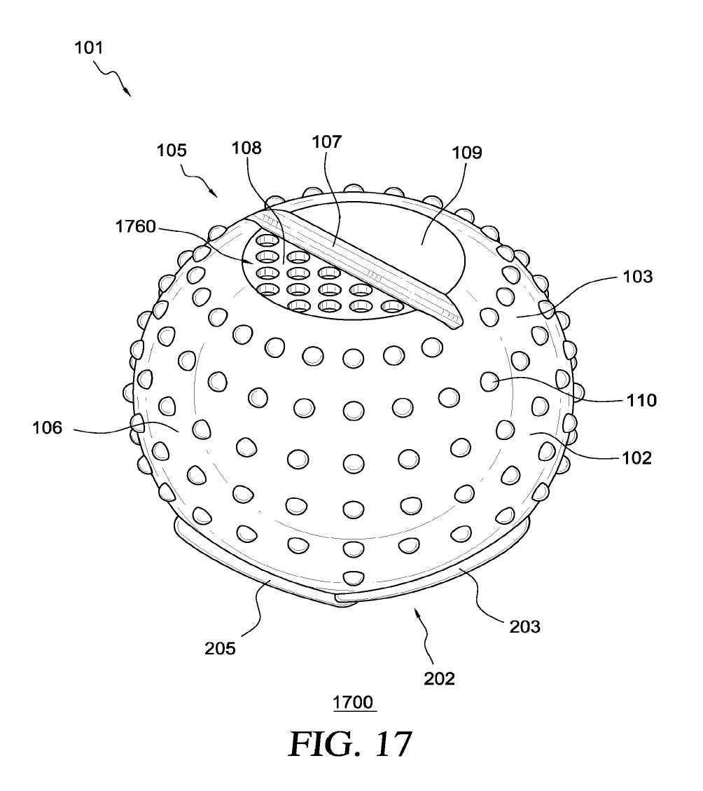

FIG. 17 illustrates cover 1700 similar to cover 100, according to a fourth embodiment. In many embodiments, wall 102 of FIG. 17 can further comprise at least one passage 1760. In some embodiments, each passage 1760 can have a 3.18 mm diameter. In various embodiments, the at least one passage 1760 can strain liquid from the object of the multiple objects while retaining solids.

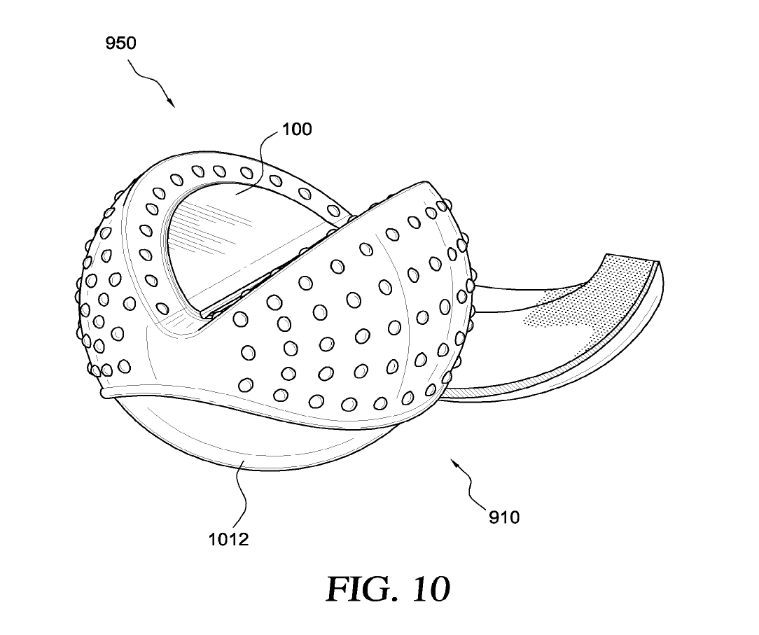

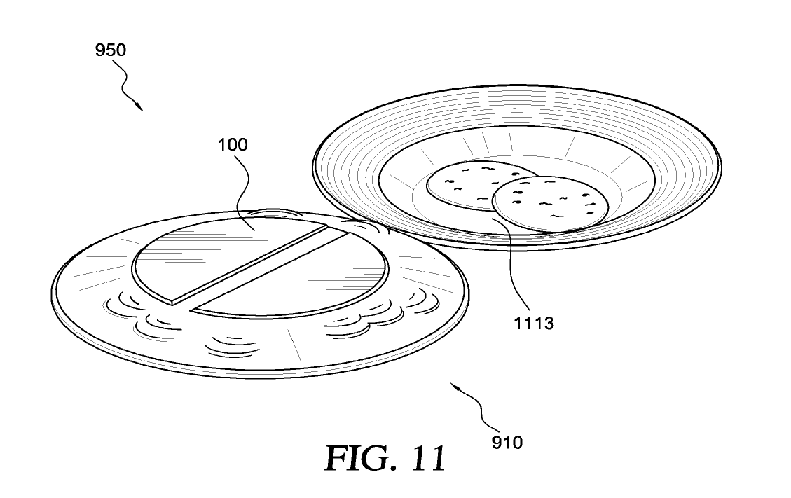

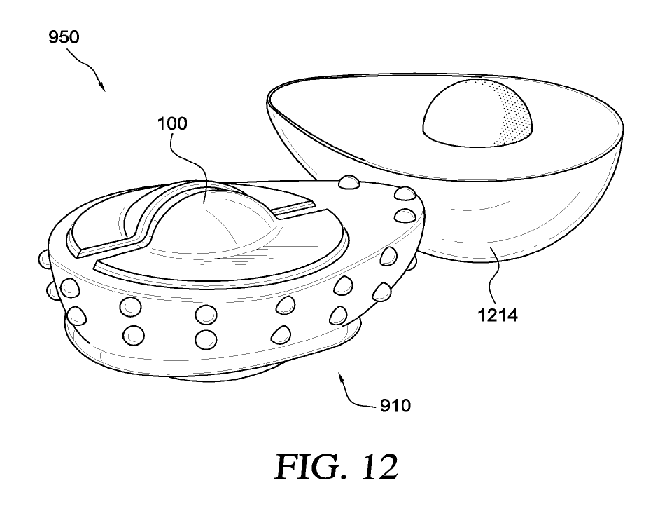

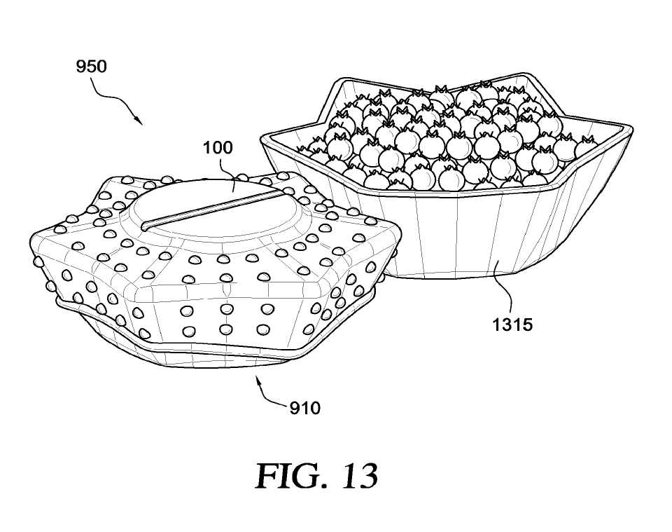

FIGS. 9-13 illustrate various examples of objects of the multiple objects 910 that can be covered with cover 100 (FIG. 1), according to the first embodiment. FIG. 9 illustrates one example of an object of multiple objects 910 wherein the object comprises a bowl of pancake batter 911 with handles and pouring spouts integral with the rim. FIG. 10 illustrates another example of an object of multiple objects 910 wherein the object comprises a melon 1012. FIG. 11 illustrates a further example of an object of multiple objects 910 wherein the object comprises a plate 1113 having food on top. FIG. 12 illustrates another example of an object of multiple objects 910 wherein the object comprises an avocado 1214 with the pit remaining FIG. 13 illustrates another example of an object of the multiple objects 910 wherein the object comprises a bowl of blueberries 1315 having an uneven surface.

Next, another embodiment can comprise a method of covering multiple objects having irregular shapes. In some embodiments, the method can comprise sealing an inner surface of a spheroid to any object of the multiple objects. In the same or different embodiments, the spheroid can be similar or identical to spheroid 101 as described above with respect to FIGS. 1-6 and 8-14. In many embodiments, the method can be configured to prevent liquids or liquid-solid mixtures from spilling or leaking from the object of the multiple objects. In other embodiments, the method can restrict the contact of gases (e.g., air) with the object of the multiple objects.

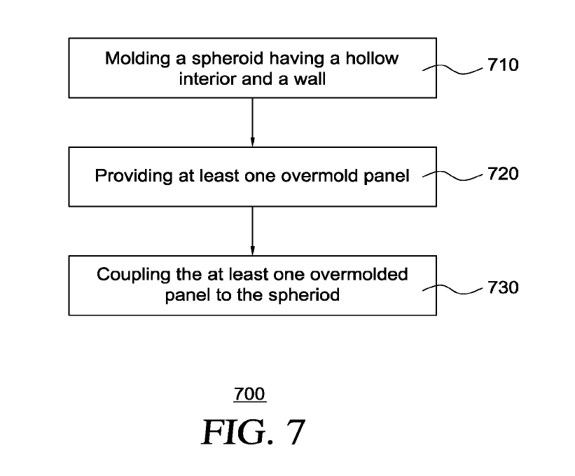

Now, referring back to the figures, FIG. 7 illustrates a flowchart of method 700 for manufacturing a cover configured to be detachably secured to multiple objects having irregular shapes. In some embodiments, the cover can be similar or identical to cover 100 (FIG. 1), at least parts of which are shown in FIGS. 1-6 and 8-14. Method 700 can comprises procedure 710 of molding a spheroid having a hollow interior and a wall. The spheroid for procedure 710 can be similar or identical to spheroid 101 (FIG. 1), as described above with respect to FIG. 1-FIG. 5. In some embodiments, procedure 710 of molding a spheroid can comprise injection molding the spheroid. In the same or different embodiments, the injection mold plates can be comprised of machined steel. In the same or different embodiments, the injection mold plates can be textured using a method comprising sand-blasting.

Referring to FIG. 7, method 700 can further comprise procedure 720 of providing at least one overmolded panel. The overmolded panel for procedure 710 can be similar or identical to overmolded panel 601, as described above with respect to FIG. 6. In some embodiments, procedure 720 of providing at least one overmolded panel comprises molding an overmolded panel. In various embodiments, procedure 720 can comprise injection molding the overmolded panel. In other embodiments, procedure 720 can comprise furnishing an overmolded panel.

Referring to FIG. 7, method 700 can further comprise procedure 730 of coupling the at least one overmolded panel to the spheroid. In some embodiments, procedure 730 of coupling the at least one overmolded panel to the spheroid can comprise molding the overmolded panel to the spheroid. In various embodiments, procedure 730 can comprise injection molding the overmolded panel to the spheroid. In other embodiments, procedure 730 can comprise injection molding the spheroid to the overmolded panel. In some embodiments, procedures 720 and 730 can be omitted. In other embodiments, procedure 720 can occur before procedure 710. In the same or different embodiments, procedure 710 and procedure 730 can occur simultaneously. In further embodiments, procedure 730 of coupling the at least one overmolded panel to the spheroid can comprise bonding the at least one overmolded panel to the spheroid with an adhesive.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 710, 720, and 730 of FIG. 7 may be comprised of many different activities and that these procedures and activities may be performed by many different modules, in many different orders, that any element of FIGS. 1-17 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A cover configured to be detachably secured to multiple objects having irregular shapes, the cover comprising:
a spheroid comprising a hollow interior and a wall;
wherein:
the wall comprises a material, an outer surface, an inner surface, and an aperture providing an opening through the wall into the hollow interior;
the spheroid is configured to be altered from a relaxed state to a deformed state without permanently deforming the spheroid;
when the spheroid is in the relaxed state, the hollow interior has a first greatest dimension and the aperture has a second greatest dimension smaller than the first greatest dimension;
when the spheroid is in the deformed state, the spheroid is configured to conform to any object of the multiple objects and to provide a seal for the object of the multiple objects; and
when the spheroid is in the deformed state, the spheroid is capable of providing forces in three dimensions such that the spheroid is capable of gripping the object in the three dimensions.

2) The cover of claim 1 wherein the multiple objects comprise at least two of:
a container having an opening and an exterior surface adjacent to the opening, wherein at least one of the opening or the exterior surface adjacent to the opening is uneven;
an exposed internal section of a piece of produce;
a receptacle having a height above which are perishable goods; or
a pitcher having at least one spout.

3) The cover of claim 1 wherein the multiple objects comprise at least two of:
an exposed portion of a melon;
an exposed portion of an avocado having a pit of the avocado still remaining;
an exposed portion of a mango having a pit of the mango still remaining;
an exposed portion of a pineapple;
a cucumber having an exposed surface of the cucumber, wherein the exposed surface of the cucumber is uneven;
an exposed portion of a pear;
an exposed portion of a coconut;
an exposed portion of a pepper;
an exposed portion of an onion;
an exposed portion of an orange;
an exposed portion of an grapefruit;
an exposed portion of a lemon;
an exposed portion of a lime;
an exposed portion of an apple;
an exposed portion of a tomato;
a measuring cup having at least one measuring cup spout;
a gravy boat having at least one gravy boat spout;
a first container having a first opening and a first exterior surface adjacent to the first opening, wherein:
at least one of the first opening or the first exterior surface adjacent to the first opening is uneven; and
the first container is a dish;
a second container having a second opening and a second exterior surface adjacent to the second opening, wherein:
at least one of the second opening or the second exterior surface adjacent to the second opening is uneven; and
the second container is a bowl;
a third container having a third opening and a third exterior surface adjacent to the third opening, wherein:
at least one of the third opening or the third exterior surface adjacent to the third opening is uneven; and
the third container is a vessel for fluids, the vessel for fluids comprising at least one of a cup, mug, or glass;
a first receptacle, wherein:
the first receptacle has a first height above which are first perishable goods; and
the first perishable goods comprise at least one hamburger;
a second receptacle, wherein:
the second receptacle has a second height above which are second perishable goods; and
the second perishable goods comprise at least one sandwich;
and
a third receptacle, wherein:
the third receptacle has a third height above which are third perishable goods; and
the third perishable goods comprise at least one piece of produce.

4) The cover of claim 1 wherein:
the material comprises at least one of:
an elongation at break greater than or equal to 1000%;
a tensile modulus at 100% of less than 138 kilopascals; or
a hardness of less than 10 Shore A.

5) The cover of claim 1 wherein:
the material comprises at least one of a thermoplastic elastomer, a thermoplastic rubber, a styrene block copolymer, or a hydrogenated isoprene.

6) The cover of claim 1 wherein:
the outer surface comprises a top region opposite the aperture and also comprises at least one other portion; and
the top region is substantially flat.

7) The cover of claim 6 wherein:
the top region comprises at least one hinge; and
the at least one hinge divides the top region into at least a first panel and a second panel.

8) The cover of claim 7 wherein at least one of:
the first panel and the second panel are substantially equally sized;
when the spheroid is in the relaxed state, the first panel is coplanar with the second panel;
when the spheroid is in the deformed state, the first panel is not coplanar with the second panel;
the first panel and the second panel are thicker than the at least one other portion of the outer surface; or
at least one of the first panel or the second panel is configured to include at least one of an identification mark, a logo, or a customized label.

9) The cover of claim 1 wherein at least one of:
the wall has a thickness greater than or equal to approximately 0.79 millimeters and less than or equal to approximately 3.18 millimeters; or
the first greatest dimension is greater than or equal to approximately 1.91 centimeters and less than or equal to approximately 15.24 centimeters.

10) The cover of claim 1 wherein:
the outer surface comprises at least one portion, and the at least one portion comprises nubs; and
at least one of:
the nubs are spread evenly across the at least one portion of the outer surface; or
the nubs comprise the shape of at least one of a hemisphere, a cone, a pyramid, a prism, a face, an animal, a fruit, or a vegetable.

11) The cover of claim 1 wherein at least one of:
the outer surface comprises an annular ring around the aperture; or
the outer surface comprises a tab adjacent to the aperture.

12) The cover of claim 1 wherein:
the spheroid has a shape of any one of a sphere, an ellipsoid, a spherical cap, a spherical frustum, or any three dimensional polygon having a substantially spherical shape.

13) The cover of claim 1 further comprising:
at least one overmolded panel coupled to the wall.

14) The cover of claim 1 wherein:
the wall further comprises at least one 3.18 millimeter passage providing a second opening through the wall into the hollow interior.

15) The cover of claim 1 wherein:
the outer surface is textured; and
the inner surface is smooth.

16) The cover of claim 1 wherein:
the material comprises an elongation at break greater than or equal to 1000%;
the material comprises a tensile modulus at 100% less than 138 kilopascals;
the material comprises a hardness of less than 8 Shore A;
the outer surface comprises a top region opposite the aperture and at least one other portion;
the top region is substantially flat;
the top region comprises at least one hinge;
the at least one hinge divides the top region into at least a first panel and a second panel;
the at least one other portion of the outer surface comprises nubs;
the outer surface comprises an annular ring around the aperture; and
the outer surface comprises a tab adjacent to the aperture.

17) A method of covering multiple objects having irregular shapes, the method comprising:
sealing an inner surface of a spheroid to any object of the multiple objects;
wherein:
the wall comprises an outer surface, an inner surface, and an aperture providing an opening through the wall into the hollow interior;
the spheroid is configured to be altered from a relaxed state to a deformed state without permanently deforming the spheroid;
when the spheroid is in the relaxed state, the hollow interior has a first greatest dimension and the aperture has a second greatest dimension smaller than the first greatest dimension;
when the spheroid is in the deformed state, the spheroid is configured to conform to any object of the multiple objects and to provide a seal for the object of the multiple objects; and
when the spheroid is in the deformed state, the spheroid is capable of providing forces in three dimensions such that the spheroid is capable of gripping the object in the three dimensions.

18) A method of manufacturing a cover configured to be detachably secured to multiple objects having irregular shapes, the method comprising:
molding a spheroid having a hollow interior and a wall;
wherein:
the wall comprises an outer surface, an inner surface, and an aperture providing an opening through the wall into the hollow interior;
the spheroid is configured to be altered from a relaxed state to a deformed state without permanently deforming the spheroid;
when the spheroid is in the relaxed state, the hollow interior has a first greatest dimension and the aperture has a second greatest dimension smaller than the first greatest dimension;
when the spheroid is in the deformed state, the spheroid is configured to conform to any object of the multiple objects and to provide a seal for the object of the multiple objects; and
when the spheroid is in the deformed state, the spheroid is capable of providing forces in three dimensions such that the spheroid is capable of gripping the object in the three dimensions.

19) The method of claim 18 wherein:
molding the spheroid comprises injection molding the spheroid.

20) The method of claim 18 further comprising:
providing at least one overmolded panel; and
coupling the at least one overmolded panel to the spheroid.
